(19) United States
(12) Patent Application Publication
(10) Pub. No.: US 2012/0257231 A1
(43) Pub. Date: Oct. 11, 2012

(54) IMAGE READING APPARATUS, CONTROL METHOD FOR IMAGE READING APPARATUS, AND STORAGE MEDIUM

(75) Inventor: Minoru Akazawa, Kawasaki-shi (JP)

(73) Assignee: CANON KABUSHIKI KAISHA, Tokyo (JP)

(21) Appl. No.: 13/434,659

(22) Filed: Mar. 29, 2012

(30) Foreign Application Priority Data
Apr. 5, 2011 (JP) 2011-083688

(51) Int. Cl. G06K 15/16

(52) U.S. Cl. 358/1.12

(57) ABSTRACT

An image reading apparatus includes a conveyance unit, a reading unit, a detection unit, and a control unit. The conveyance unit conveys a document via a conveyance path. The reading unit reads an image of a first surface or a second surface of the document conveyed by the conveyance unit. The detection unit detects a conveyance state of the document on the conveyance path. The control unit performs control to display, on a display unit, a position of the document, and front information or back information indicating, respectively, the first surface and the second surface of the document according to the conveyance state of the document detected by the detection unit.

### BACKGROUND OF THE INVENTION

1. Field of the Invention

The present invention relates to an image reading apparatus, a control method for an image reading apparatus, and a storage medium.

2. Description of the Related Art

With an image forming apparatus such as a copying machine or a multifunction peripheral, a document reading unit reads a document, image processing is performed, and an image is printed on a recording medium, e.g., a sheet, or is transmitted to a device at the connection destination. The document reading unit in the image forming apparatus includes an image reading apparatus, in which a plurality of documents is stacked and set, then is automatically conveyed to the document reading unit one by one, and an image is read.

The image reading apparatus has a function for reversing the conveyed document therein and automatically reading front and back surfaces as two sides of the document. Therefore, the productivity of the image reading apparatus is excessively improved as compared with the case of manually feeding the document page by page instead of automatically conveying and reading the document.

However, since the image reading apparatus automatically conveys and reverses the document with an internal mechanism, if the document is skewed or the document is not flat but is creased, a document jam may occur.

If such a document jam occurs during execution of two-sided reading of the document, after a user removes the jammed document, the user does not readily determine which one of the front and back surfaces of the document is to start to be read again. As a consequence, it is troublesome for the user to set again the document and restart reading of the document.

In this respect, Japanese Patent Application Laid-Open No. 2003-134300 discusses a technique for counting up the number of document pages read by a document reading unit and displaying a page number with which to start rereading if the document gets jammed. With the technique, if the document whose front and back surfaces as two sides are being read gets jammed, an operation unit displays a notification indicating the document jam and the page number with which to start rereading. Therefore, the user can readily set the document for rereading.

However, if page numbers are not assigned to a plurality of sheets of a two-sided document and the user does not grasp the arrangement of sheets of the document, when the document gets jammed during reading of two sides, with the technique discussed in Japanese Patent Application Laid-Open No. 2003-134300, the documents cannot be properly set again.

With the conventional image reading apparatus, the front surface of the document is first read, the document is next reversed in the reading unit, and the back surface of the document is read. In this situation, the document position is opposite to that taken during input of the document. Therefore, the document is reversed again in the reading unit after reading the back surface, the direction of the document is reset, and the document is discharged. During two-sided reading, the document is reversed twice in the apparatus. If the document gets jammed, when the document is to be reread, the user does not determine with which one of the front and back surfaces of the document to restart reading.

Further, another image reading apparatus is devised to improve the performance of two-sided reading by reading the document at high speed while permuting the reading.

In such a high-speed image reading apparatus, two documents can be located on a conveyance path. The documents are read in the following order: the front surface of a first document, the front surface of a second document, the back surface of the first document, and the back surface of the second document. Thus, the front surface of the second document is read at timing corresponding to the time of reversal of the document for two-sided reading in a conventional image reading apparatus, thereby increasing the reading speed.

However, in such an image reading apparatus, if the documents get jammed, a user who does not grasp the arrangement order of documents does not recognize the front or back surface of two documents on the conveyance path. In this case, when setting again the documents, the user cannot readily determine with which one of the front and back surfaces faced up to restart reading.

### SUMMARY OF THE INVENTION

According to an aspect of the present invention, an image reading apparatus includes a conveyance unit configured to convey a document via a conveyance path, a reading unit configured to read an image of a first surface or a second surface of the document conveyed by the conveyance unit, a detection unit configured to detect a conveyance state of the document on the conveyance path, and a control unit configured to perform control to display, on a display unit, a position of the document, and front information or back information indicating, respectively, the first surface or the second surface of the document according to the conveyance state of the document detected by the detection unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a block diagram of a configuration of an image reading apparatus according to a first exemplary embodiment.

FIG. 2 illustrates a cross-sectional view of a specific configuration of the image reading apparatus in FIG. 1 according to the first exemplary embodiment.

FIG. 3 illustrates cross-sectional views of document conveyance states of the image reading apparatus according to the first exemplary embodiment.

FIG. 4 illustrates a flowchart of a control procedure for the image reading apparatus according to the first exemplary embodiment.

FIG. 5 illustrates various pieces of jam information displayed on an operation unit in the image reading apparatus according to the first exemplary embodiment.

FIG. 6 illustrates various pieces of jam information displayed on the operation unit in the image reading apparatus according to the first exemplary embodiment.

FIG. 7 illustrates an example of a user interface displayed on the operation unit according to the first exemplary embodiment.

FIG. 8 illustrates a specific configuration of an image reading apparatus according to a second exemplary embodiment.

FIG. 9 illustrates cross-sectional views of document conveyance states in the image reading apparatus according to the second exemplary embodiment.

FIG. 10, which is composed of FIGS. 10A and 10B, illustrates a flowchart of a control procedure for the image reading apparatus according to the second exemplary embodiment.

FIG. 11 illustrates cross-sectional views of document conveyance states in the image reading apparatus according to the second exemplary embodiment.

FIG. 12 illustrates cross-sectional views of document conveyance states in the image reading apparatus according to the second exemplary embodiment.

FIG. 13 illustrates an example of a user interface displayed on an operation unit in the image reading apparatus according to the second exemplary embodiment.

### DESCRIPTION OF THE EMBODIMENTS

Various exemplary embodiments, features, and aspects of the invention will be described in detail below with reference to the drawings.

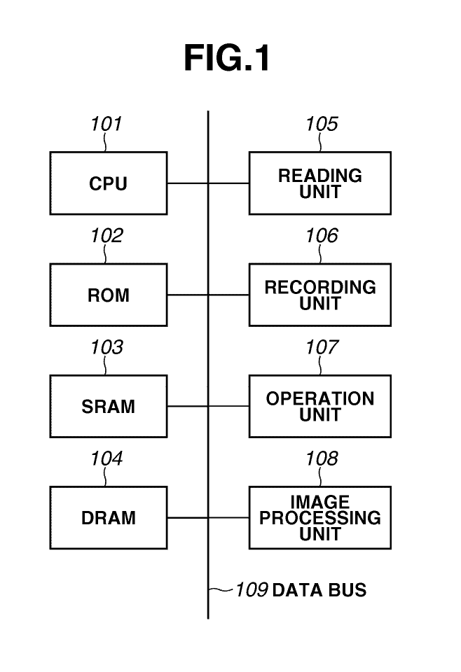

FIG. 1 illustrates a block diagram of a configuration of an image reading apparatus according to a first exemplary embodiment. According to the first exemplary embodiment, a copying machine having the image reading apparatus is used as an example.

Referring to FIG. 1, a central processing unit (CPU) 101 is a system control unit that entirely controls the image reading apparatus. A read only memory (ROM) 102 stores a control program for the CPU 101. A static random access memory (SRAM) 103 stores setting values registered by an operator, apparatus management data, or buffers for various works. A dynamic random access memory (DRAM) 104 stores program control variables. A reading unit 105 reads image data of a one-sided or two-sided document, and converts the read image data into binary data. With the binary data, the reading unit 105 performs document reading with a copy function.

The reading unit 105 includes a conveyance path and a read sensor for automatically conveying a one-sided or two-sided document and reading the document. Further, the image reading apparatus automatically reverses the document therein, and reads the front and back surfaces of the document. A recording unit 106 outputs the image data to a recording sheet.

An operation unit 107 displays information about the image reading apparatus and allows the user to perform various settings and to input data for starting the reading. An image processing unit 108 performs coding/decoding processing of image data for a copying operation. The image processing unit 108 also executes zoom processing of a copy image. Control units thereof are connected to each other via a data bus 109, and the image data is transferred to the SRAM 103 via the data bus 109.

According to the present exemplary embodiment, an example is described about copy processing for placing the document on the reading unit 105, temporarily storing the image data read by using the image reading apparatus to the SRAM 103, and printing the data by the recording unit 106.

With the copy machine having the above-described configuration, the user performs an input operation by using the operation unit 107, thereby changing the copy settings and issuing an instruction. The copy settings include two-sided reading. In the case of the two-sided reading, the image reading apparatus of the reading unit 105 automatically reverses the document, and reads both the front and back surfaces.

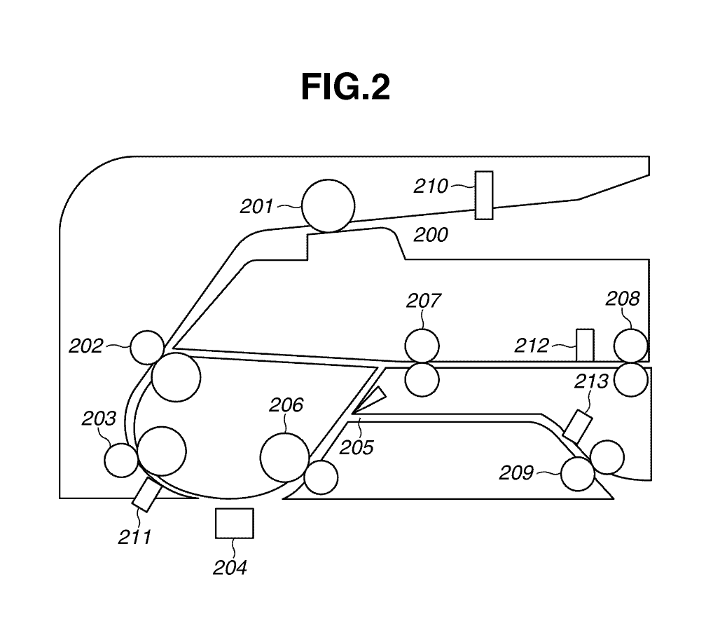

FIG. 2 illustrates a cross-sectional view of a specific configuration of the image reading apparatus in FIG. 1. According to the present exemplary embodiment, rollers 201 to 203, 206, and 207 to 209 function as a conveyance unit that conveys the two-sided document placed on a document positioning plate 200 via a plurality of conveyance paths. A reversal roller is described below.

Referring to FIG. 2, the document is placed on the document positioning plate 200. Then, the document is conveyed via the rollers 201 to 203. When the document passes through a read sensor 204 (image sensor), the front surface is read. Thereafter, the document passes through the roller 206, and further passes through an upper conveyance path with a flapper 205 moved down. Further, the document passes through the roller 207, and the reversal roller 208 temporarily moves the document outside the image reading apparatus. The reading processing of the front surface of the document ends. The read sensor 204 reads an image of a conveyed document surface at a predetermined position. Thus, the read sensor 204 individually reads the front and back surfaces of the conveyed document.

Subsequently, the reversal roller 208 is reversely rotated to move backward the document, and the read sensor 204 reads the back surface after the documents passes through the rollers 207, 202, and 203. Similar to the reading processing of the front surface, the flapper 205 is moved down, and the document passes through the upper conveyance path. Further, the reversal roller 208 moves again the document outside the image reading apparatus via the rollers 206 and 207. Then, the two-sided reading of the document ends. If the document is discharged in this state, the arrangement order of surfaces of the document is opposite to that taken when the document is placed on the document positioning plate 200.

Therefore, in order to reverse again the document, the reversal roller 208 is reversely rotated again to move backward the document. The document passes through the rollers 207, 202, 203, and 206, and then passes through the lower conveyance path with the flapper 205 moved up. In this case, the read sensor 204 does not read the document. Finally, the document reaches the discharge roller 209, and the document is discharged outside the image reading apparatus.

The image reading apparatus has a mechanical configuration. Therefore, if the document is skewed or an edge of the document is creased, the document can come into contact with the conveyance path, that is, the document may get jammed. Thus, sensors 210, 211, 212, and 213 are arranged at positions on the conveyance path for conveying the document to detect whether there is a document, further detect whether the document gets jammed, or furthermore detect the jam position.

The sensor 210, which detects a document stack state, detects whether the document is set on the document positioning plate 200. Then, information indicating the detection state is notified to the CPU 101.

The sensor 211 for detecting a document conveyance state and the sensor 213 for detecting a sheet discharge state detect whether the document gets jammed by detecting whether the sensors are not switched on/off for a predetermined time. The sensor 212 for detecting the reversed and conveyed document is arranged to the inner position of the position of the roller 208, and monitors a conveyance state of the reversed document.

The sensors 211, 213, and 212 are used for detecting the document position when the document gets jammed. According to the present exemplary embodiment, the sensors 211, 213, and 212 are provided as a plurality of detection units for detecting conveyance states of the document passing through the conveyance paths.

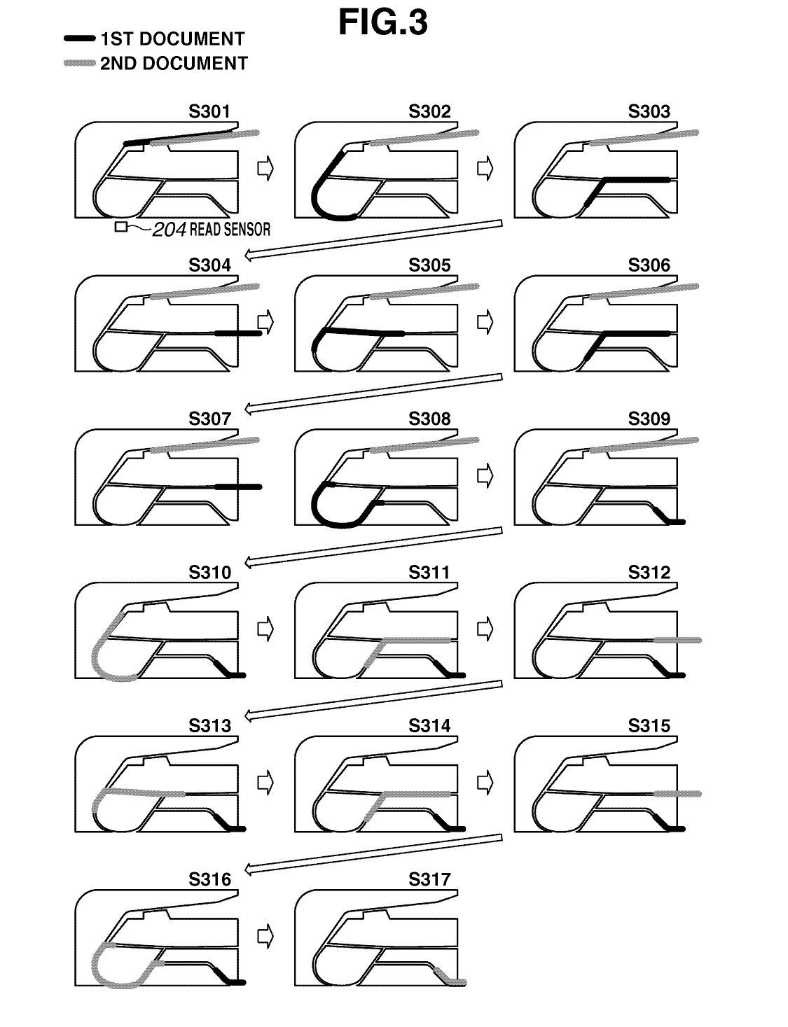

FIG. 3 illustrates cross-sectional views of the document conveyance states of the image reading apparatus according to the present exemplary embodiment. Referring to FIG. 3, the reading unit 105 in FIG. 1 performs two-sided reading of two documents, as an operation example. S301 to S317 indicate timing. In this example, in the image reading apparatus according to the present exemplary embodiment, only one document is conveyed onto the conveyance path at a time, thereby reading the two-sided document. After ending the two-sided reading, the next document is conveyed, and two-sided images are read.

Referring to FIG. 3, two documents are stacked, and the front surface is faced up and is placed on the image reading apparatus. When the user instructs starting the two-sided reading of the document via the operation unit 107, the two-sided reading starts.

At time S301, the CPU 101 controls the driving of the roller 201 to convey the first document onto the conveyance path. At time S302, the first document passes through the read sensor 204 while the front surface is faced down, and the front surface of the first document is scanned. After completion of reading the front surface of the first document, the document is reversed to read the back surface.

At times S303 and S304, the CPU 101 drives the rollers 206 and 207, temporarily sends the document toward the roller 208, and enters a reversal standby mode. At time S305, in order to scan the back surface of the first document, the CPU 101 controls the driving of the rollers 208, 207, 202, and 203, and the reversed document is sent again to the read sensor 204.

At this time, the back surface of the document is faced up, and the document is conveyed so that the rear edge of the document becomes a leading end. At time S306, the document is sent along the conveyance path, the document passes through the read sensor 204 again while the back surface is faced down, and the back surface is scanned.

Then, the reading of the front and back surfaces of the document ends. If the document is discharged in this state, the documents are discharged in the page order opposite to that of the documents when being placed on the document positioning plate 200. Therefore, the document is reversed again before being discharged.

At time S307, the CPU 101 controls the driving of the rollers 207 and 208, moves forward again the document, and enters a reversal standby mode. At time S308, the document passes through the conveyance path, and is reversed again. At time S309, the CPU 101 finally controls the driving of the roller 209 so that the document passes through the conveyance path for discharge and is discharged to the document positioning plate 200.

After ending reading the front and back surfaces of the first document, at time S310, the second document starts to be read. Although the two-sided reading of the second document is as illustrated at times S310 to S317, the operation is similar to that of the first document and is not described. The two-sided reading is realized in the image reading apparatus according to the present exemplary embodiment by scanning the front surface, reversing the document, scanning the back surface, reversing again the document, and discharging the document.

A description is given of processing for detecting the jam by the sensors 210 to 213 in FIG. 2 by the CPU 101, further detecting the jam position, and performing processing for displaying jam information on the operation unit 107 according to the jam position if the document gets jammed during conveyance of the document. Images 5-1 to 5-8 corresponding to display images are stored in the ROM 102. The user checks a screen displayed on the operation unit 107, and can intuitively know the jam position of the jammed document and which one of the front and back surfaces a surface of the jammed document is.

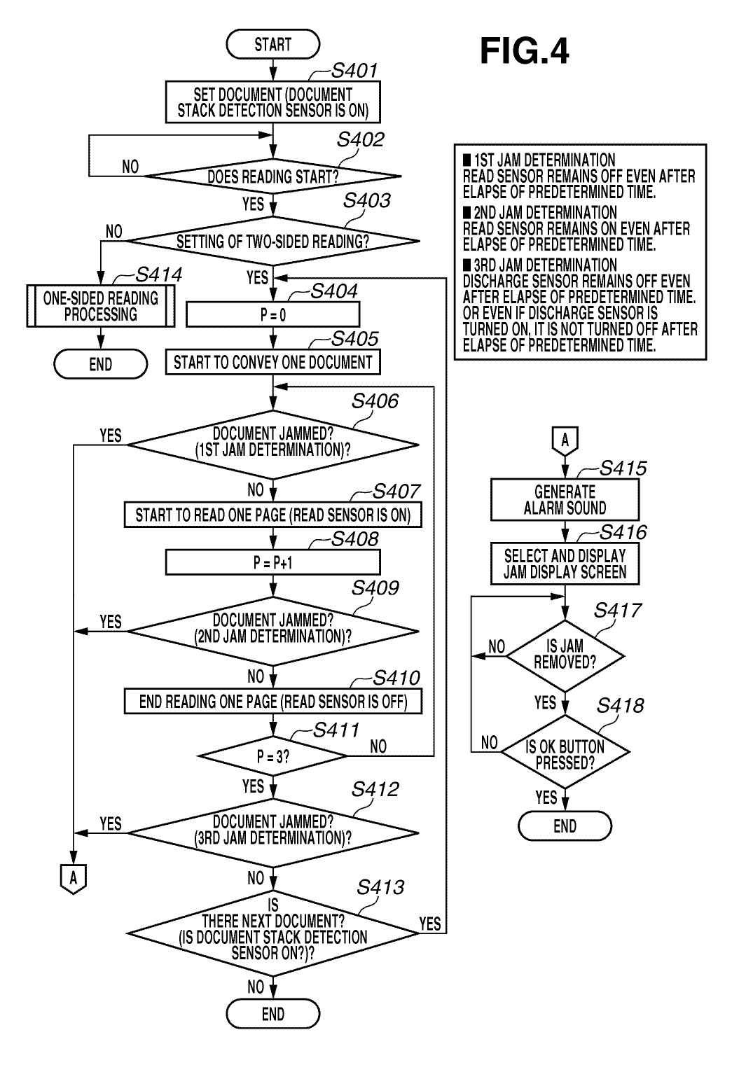

FIG. 4 illustrates a flowchart of a control procedure for the image reading apparatus according to the present exemplary embodiment. According to the present exemplary embodiment, the CPU 101 in the image reading apparatus detects the jam and displays a jam position image indicating the jam position. Steps are realized by loading a control program stored in the ROM 102 to the DRAM 104 and executing the program by the CPU 101. Hereinbelow, a description is given of processing by the CPU 101 for determining the jam position where the document gets jammed and a conveyance surface of the jammed document stopping at the jam position based on the change of the conveyance state of the document detected by the sensors 210 to 213 and the number of passing times of the document through the read sensor 204. Further, a description is given of control to display the jam information on the operation unit 107 by executing the steps by the CPU 101.

In step S401, the user sets the document on the document positioning plate 200, and the CPU 101 detects a setting state of the document when the sensor 210, which detects the document stack state, is turned on. In step S402, the CPU 101 waits the user to perform various reading settings on the operation unit 107 and press a button for starting the reading.

After the CPU 101 detects that the button for starting the reading is pressed, the CPU 101 starts to convey the document and read the document. After starting the reading, in step S403, the CPU 101 determines whether a reading mode set by the user via the operation unit 107 indicates the one-sided reading or the two-sided reading of the document.

If the CPU 101 determines that the one-sided reading is set (NO in step S403), then in step S414, the CPU 101 executes processing for the one-sided reading. Since specific processing contents of the one-sided reading are out of the essentials, they are not described here.

If the CPU 101 determines that the two-sided reading is set (YES in step S403), then in step S404, the CPU 101 sets “0” to a parameter P stored in the DRAM 104. In step S405, the CPU 101 feeds the document set by driving the roller 201 and starts to convey the document.

The document, which has started to be conveyed, is waited to reach the read sensor 204. In step S406, the CPU 101 determines whether the document gets jammed depending on whether the sensor 211 is turned on within a predetermined time. When the CPU 101 determines that the sensor 211 is turned on within the predetermined time (NO in step S406), then in step S407, the CPU 101 starts to read the conveyed document via the read sensor 204. The conveyance speed of the read document changes depending on a set reading condition, e.g., copy magnification, as compared with that at the same magnification.

In step S408, the CPU 101 increments the parameter P every time the document is read. The parameter P indicates the number of passage times of one document through the sensor 211 in two-sided reading at one time.

In step S409, the CPU 101 determines whether the document gets jammed by determining whether the sensor 211 remains on during the passage of the document through the read sensor 204 and is then turned off after the elapse of a predetermined time. If the CPU 101 detects that the sensor 211 is turned off after the elapse of the predetermined time (NO in step S409), then in step S410, the CPU 101 determines that the document passes through the read sensor 204, and the reading of one page ends.

The parameter P can be any of 1, 2, and 3. If P=1, the front surface is read. If P=2, the back surface is read. If P=3, the situation indicates that the edge passes through the sensor 211 when the document is reversed during discharge of the document.

If P=1 or 2, the CPU 101 reverses again the document to convey the document to the read sensor 204. Returning to step S406, the CPU 101 waits the sensor 211 to be turned on again within the predetermined time. If P=3, the document is waited to be discharged.

In step S411, the CPU 101 determines whether the parameter P is “3”. If the CPU 101 determines that the parameter P is “3” (YES in step S411), that is, if the document is discharged, then in step S412, the CPU 101 determines from the state of the sensor 213 whether the discharged document gets jammed. During discharge of the document, although the document passes through the sensor 213, the sensor for detecting discharge of the document may not be turned on after the elapse of the predetermined time or the sensor may not be turned off after the elapse of a predetermined time even after turning-on of the sensor. In this state, the CPU 101 determines that the discharged document gets jammed.

If the CPU 101 determines that the discharged document does not get jammed (NO in step S412), then in step S413, the CPU 101 determines, via the sensor 210, which detects the document stack state, whether there is still a document on the document positioning plate 200. If the CPU 101 determines that there is a document on the document positioning plate 200 (YES in step S413), the processing returns to step S404, in which the parameter P is cleared to zero and a next document starts to be conveyed.

If the CPU 101 determines that there is no document on the document positioning plate 200 (NO in step S413), the processing ends.

If the CPU 101 determines that the document gets jammed in step S406, S409, or S412, the processing proceeds to step S415.

In step S415, the CPU 101 stops the entire document conveyance driving system, including the roller 201, and generates alarm sound notifying the user of the jam state. The image reading apparatus according to the present exemplary embodiment has a sound generation device such as a buzzer (not illustrated).

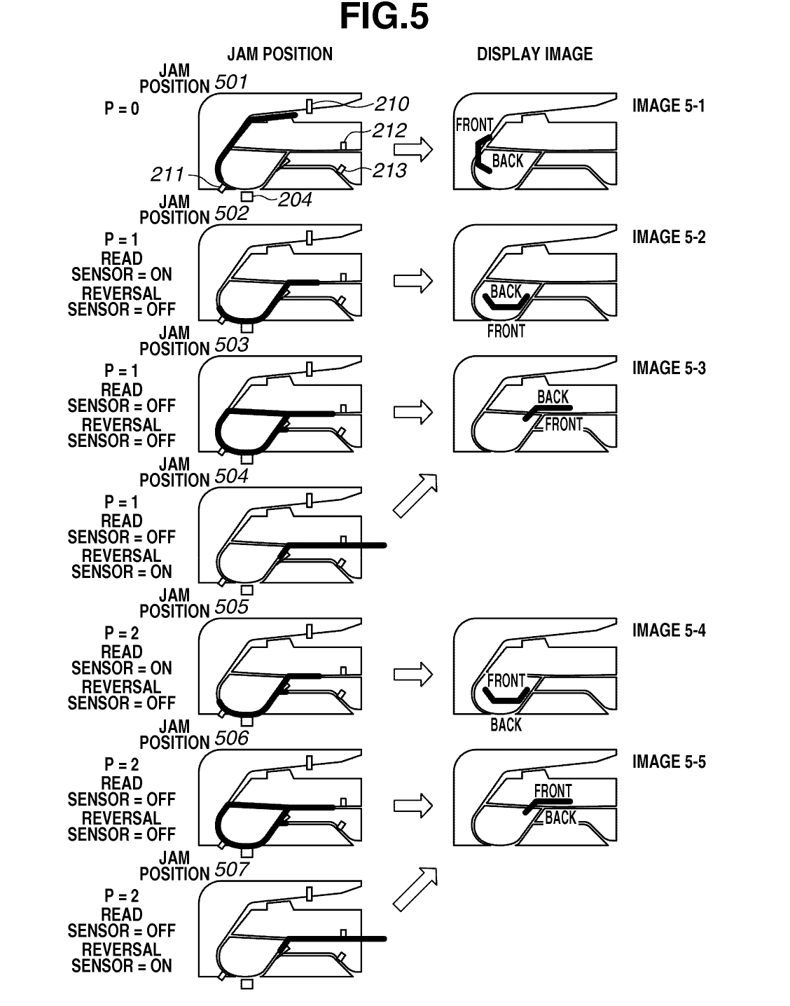

In step S416, the CPU 101 selects and displays a jam display screen on a display portion of the operation unit 107. An example in step S416 is described below with reference to FIG. 5.

In step S417, the CPU 101 detects outputs of the sensors 210 to 213 or the change in state of an open/close door (not illustrated) to check whether the user removes the jam to remove the document stopping in the jam state.

In step S418, the CPU 101 checks that the user presses an OK button of the operation unit 107 after removing the jam, then determines that the jam removal ends, and the present processing ends. According to the present exemplary embodiment, the CPU 101 executes steps S406 to S412, thereby determining which one of the front and back surfaces the upper surface of the jammed document stopping at the jam position is based on the value of the parameter P. It is possible to display the jam position of the jammed document determined by the CPU 101 and the jam information including front or back information indicating which one of the front and back surfaces of the document the upper surface of the jammed document is on the display portion of the operation unit 107. Thus, the user can place again the front surface of the jammed document as the upper surface on the document positioning plate 200, and can correctly restart the document reading.

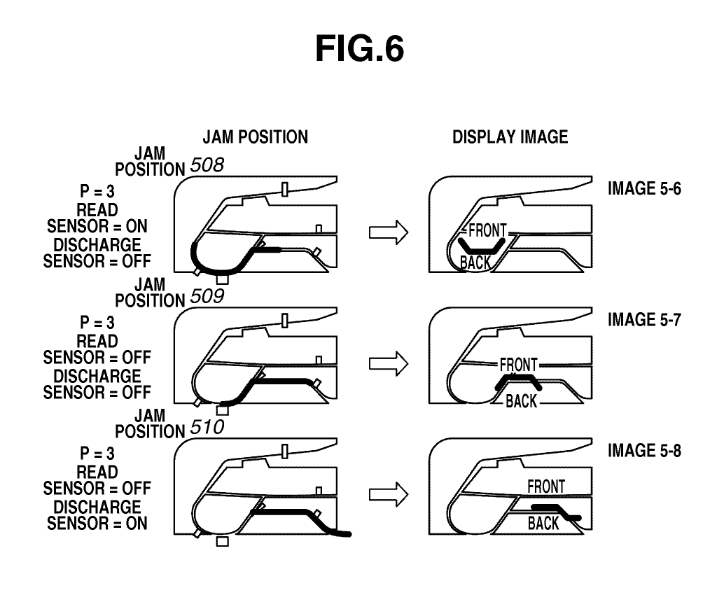

FIGS. 5 and 6 illustrate examples of the jam information displayed on the operation unit 107 in the image reading apparatus according to the present exemplary embodiment. The examples illustrate the jam information selected corresponding to the jam position where the document gets jammed during conveyance of the document in step S416 in the flowchart of FIG. 4. The jam information contains the position where the document gets jammed and information indicating the front or back surface of the jammed document.

The jam position is approximately assumed when the document gets actually jammed. The jam information to be displayed on the operation unit 107 is selectively read from the ROM 102 corresponding to the jam position determined by the CPU 101.

The display images illustrated in FIGS. 5 and 6 are examples, and may be any image with which the position and the front or back surface of the document can be clearly transmitted to the user.

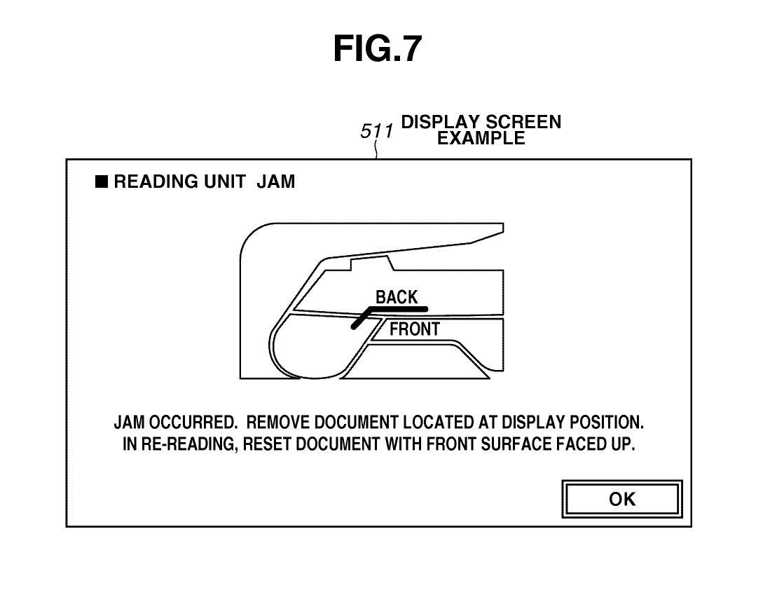

Referring to FIG. 5, if the parameter P=0, when detecting the jam by the first jam determination in step S406, the document gets jammed at a jam position 501. The CPU 101 performs control to selectively read the image 5-1 as the display image from the ROM 102 and to display the read image on the operation unit 107. Specifically, the CPU 101 reads any display image stored corresponding to a specific address in the ROM 102, and displays the read image as a user interface in FIG. 7 on the operation unit 107.

A description is given of the display image to be selected based on the value of the parameter P in FIG. 5.

If the parameter P=1, the jam is detected by the second jam determination in step S409 or the first jam determination in step S406, the document gets jammed at any of jam positions 502, 503, and 504.

In this case, the position of the document is approximately determined based on the status of the sensor 211 when detecting the jam and the sensor 212, which detects the reversal. When the sensor 211 is turned on, the CPU 101 determines that the document gets jammed during reading of the document. As a consequence, the CPU 101 selectively reads the image 5-2 as the display image from the ROM 102, and performs control to display the read image on the operation unit 107.

On the other hand, when the sensor 211 is turned off, the CPU 101 determines the approximate position of the document based on the status of the sensor 212, which detects the reversal. In this case, irrespective of ON/OFF of the sensor 211, the CPU 101 selectively reads the image 5-3 as the display image to be transmitted to the user from the ROM 102, and performs control to display the read image on the operation unit 107.

If the parameter P=2, when the jam is detected by the second jam determination in step S409 or the first jam in step S406, similarly to the jam positions 502, 503, and 504 of the document when P=1, jam positions 505, 506, and 507 are determined. Therefore, the display image depending on the situation may be similar. However, the direction of the front and back surfaces is different from that when P=1, and images 5-4 and 5-5 are, therefore, prepared as the display images.

Referring to FIG. 6, if the parameter P=3, when the jam is detected by the second jam determination in step S409 or the third jam determination in step S412, the document gets jammed at any of jam positions 508, 509, and 510.

In this case, the position of the document can be approximately grasped based on the status of the sensor 211 when the jam is detected and the discharge sensor 213. If the sensor 211 is turned on, the document passes through the sensor 211 and the document, therefore, gets jammed at the jam position 508. As a consequence, the CPU 101 selectively reads the image 5-6 in FIG. 6 as the display image from the ROM 102, and performs control to display the read image on the operation unit 107.

If the CPU 101 determines that the sensor 211 is turned off and the sensor 213, which detects the discharge state, is turned off, the jam information is displayed on the operation unit 107. Specifically, the document gets jammed at the jam position 509, and the CPU 101, therefore, selectively reads the image 5-7 as the display image from the ROM 102 and performs control to display the read image on the operation unit 107.

If the CPU 101 determines that the sensor 211 is turned off and the sensor 213, which detects the discharge state, is turned on, the jam information is displayed on the operation unit 107. Specifically, the document gets jammed at the jam position 510 and the CPU 101, therefore, selectively reads the image 5-8 as the display image from the ROM 102, and performs control to display the read image on the operation unit 107.

The CPU 101 selects the display image depending on the value of the parameter P and the status of the sensors, and displays the jam information (including the jam position and the front or back surface of the document at the time of jam) on the operation unit 107.

A display screen example 511 illustrated in FIG. 7 corresponds to a user interface displayed on the operation unit 107 by selecting the image 5-3 by the CPU 101 when the document gets jammed when the parameter P=1. The CPU 101 displays the screen on the operation unit 107. As a consequence, the user can grasp that the document gets jammed in the reading unit 105, and can intuitively understand the front or back surface of the jammed document and the approximate jam position of the jammed document. Thus, the user can easily understand which one of the front and back surfaces of the document is to be faced down to be reset on the document positioning plate 200 after removing the document.

In the image reading apparatus according to the first exemplary embodiment, the document reversal processing causes the presence of a period for which the document is not read during two-sided reading. Therefore, the efficiency in the two-sided reading may deteriorate.

On the other hand, in the case of one-sided reading, the documents are sequentially conveyed from the image reading apparatus. Therefore, the documents are continuously read. When the read sensor 204 scans the document, the next document for reading is previously conveyed just before the read sensor 204. Therefore, the interval between the documents is shortened to perform the scan operation.

However, in the case of two-sided reading, the next reading surface is the back surface of the same document after scanning of the front surface. Therefore, the next document for reading is not conveyed in advance just before the read sensor 204. Thus, after the read sensor 204 reads the front surface, the document is reversed. The interval (times S303 to S305) is long to start reading the back surface. The performance in the two-sided reading is lower than that in the one-sided reading.

Further, according to the first exemplary embodiment, for a period (times S306 to S308) for re-reversing the document after reading the back surface of the document, the same conveyance path as that through which the second document passes is also used. During the re-reversal, the next document is not read. In this portion, the performance in the two-sided reading is lower than that in the one-sided reading.

According to a second exemplary embodiment, a description is given of an image reading apparatus having a document conveyance path different from that in the image reading apparatus according to the first exemplary embodiment.

According to the second exemplary embodiment, a description is given of an example of an image reading apparatus adapted to two-sided reading with high efficiency obtained by reading a document with the reading order changed. In the example of the image reading apparatus, two documents can be simultaneously conveyed on the conveyance path.

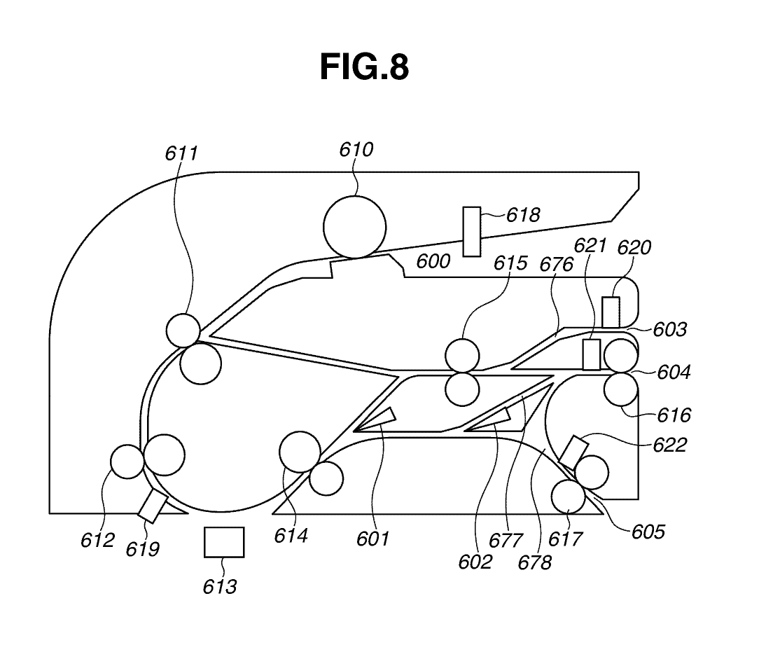

FIG. 8 illustrates a cross-sectional view of a document conveyance path in the image reading apparatus according to the second exemplary embodiment. The image reading apparatus in FIG. 8 includes two document conveyance paths. The CPU 101 controls switching of the conveyance paths via flappers 601 and 602 during conveyance of the document, thereby switching the document conveyance path.

As a first conveyance path, the document is placed on a document positioning plate 600. The document is conveyed via rollers 610, 611, and 612. When the document passes through a read sensor 613, the document is read. Then, the document passes through a roller 614. The CPU 101 moves the flapper 601 down and allows the document to pass through an upper conveyance path 676. The document passes through a roller 615, and is temporarily discharged toward an upper reversal exit 603.

After being reversed, the document passes through the rollers 615, 611, and 612. When the document passes through the read sensor 613, the back surface thereof is read.

The CPU 101 moves the flapper 601 up. The document passes through a lower conveyance path while the flapper 602 is moved up. Further, the document passes through a reversal roller 617, and is discharged again toward a lower re-reversal exit 605.

Finally, the CPU 101 drives a reversal roller 607 and a discharge roller 616, and discharges the document from a lower reversal exit 604 via the reversal roller 617 and the discharge roller 616.

As a second conveyance path, the document is placed on the document positioning plate 600. Then, the document is conveyed via the rollers 610, 611, and 612. When the document passes through the read sensor 613, the document is read. Thereafter, the CPU 101 drives the roller 614 so that the document passes through the roller 614. The CPU 101 moves the flapper 601 up and further moves the flapper 602 down, and allows the document to thus pass through a lower conveyance path 677. The CPU 101 drives the discharge roller 616 so that the document passes through the discharge roller 616. The document is temporarily discharged toward the lower reversal exit 604.

After reversing the document, the CPU 101 allows the document to pass through the rollers 615, 611, and 612 in this order. When the document passes through the read sensor 613, the back surface of the document is read. The CPU 101 moves the flapper 601 up and further moves the flapper 602 up so that the document passes through a lower conveyance path 678. The CPU 101 allows the document to be discharged toward the lower re-reversal exit 605 via the reversal roller 617. Finally, the CPU 101 allows the document to be discharged from the lower reversal exit 604 via the reversal roller 617 and the discharge roller 616.

Similar to the first exemplary embodiment, the image reading apparatus having the first and second conveyance paths also has a mechanical configuration. Therefore, the document may be jammed. In addition, to detect whether there is a document, sensors are provided to detect whether the document gets jammed and to detect the jam position.

A sensor 618, which detects the document stack state, detects whether the document is set on the document positioning plate 600. The CPU 101 detects that a sensor 619 and sensors 621 and 622 for detecting the reversed and discharged document are not turned on or off within a predetermined time. As a consequence, the CPU 101 can determine whether the document gets jammed.

The sensor 619, the sensor 621 for detecting the reversed and discharged document, and the sensors 620 and 622 for detecting the reversed document are used to detect the position of the document when the document gets jammed.

A description is given of document jam processing in the image reading apparatus having the first and second conveyance paths and a plurality of the sensors.

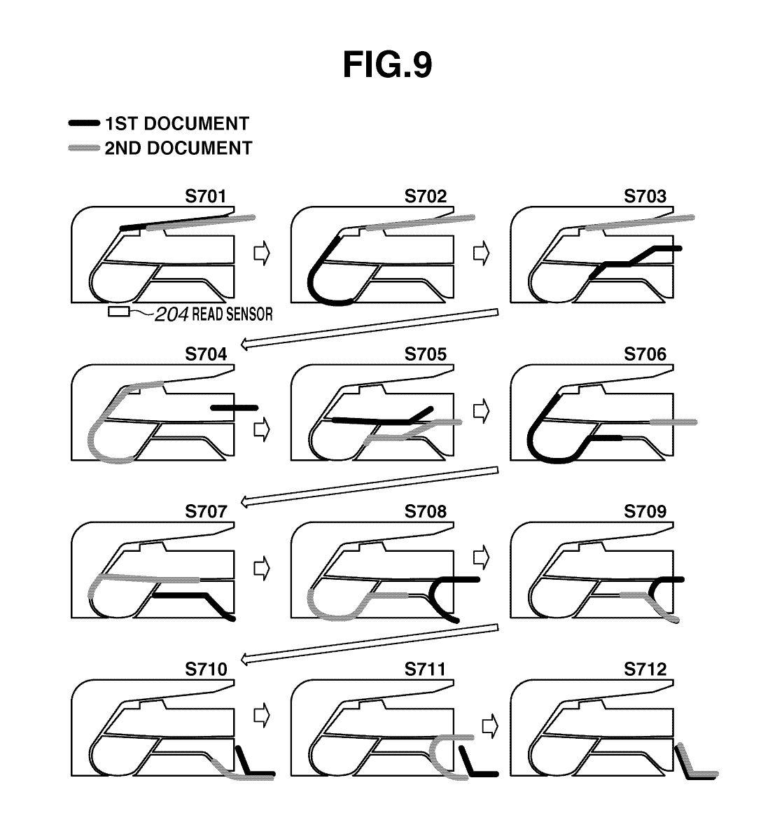

FIG. 9 illustrates cross-sectional views of document conveyance states of the document reading apparatus according to the present exemplary embodiment. In the example, two documents are simultaneously conveyed on the conveyance path. A specific description is given of an operation example for two-sided reading of two documents in the document reading apparatus. S701 to S712 indicate timings for conveying the documents.

Two documents are stacked and are set on the document positioning plate 600 in the document reading apparatus with the front surfaces faced up. With setting from the operation unit 107, the two-sided reading starts. At time S701, the CPU 101 drives the roller 610 to convey the first document to the conveyance path. At time S702, the first document passes through the read sensor 613 while the front surface thereof is faced down, and the front surface of the first document is scanned. The reading of the front surface of the first document ends. This reading can be referred to as a feeding-reading mode.

The CPU 101 reverses the document by using the document conveyance path to read the back surface thereof. First, the CPU 101 temporarily sends the document, and enters a reversal standby mode. The CPU 101 controls the position of the flapper so that the document whose front surface has been read passes through the upper conveyance path 676. At time S703, the CPU 101 starts an operation for feeding the front surface of the second document to read the front surface of the second document.

At time S704, the front surface of the second document is scanned with the read sensor 613 while the first document is first fed. Then, the first document after being reversed is conveyed again to the read sensor 613 so that the back surface of the first document is scanned. Simultaneously, the second document is first reversed to read the back surface thereof. The second document is controlled to pass through the lower conveyance path.

At time S705, the back surface of the first document is faced up, and the first document is conveyed so that the rear edge thereof becomes a leading end. The first document is fed along the conveyance path, and passes through the read sensor 613 again while the back surface thereof is faced down, thereby scanning the back surface.

At time S706, the second document is first fed via the lower conveyance path 677 and is reversed. The reading of the front and back surfaces of the first document ends. Then, the first document is reversed again. The first document passes through the read sensor 613, then passes through the lower conveyance path 678, and is reversed again. At time S707, the back surface of the second document is simultaneously faced up, the second document is conveyed in the direction in which the rear edge thereof becomes a leading end, and the reading of the back surface starts.

At time S708, the first document is reversed in the conveyance path for re-reversal, and the back surface of the second document is scanned with the read sensor 613. The first document is reversed and thereafter enters a discharge operation. At time S709, the second document enters the lower conveyance path 678 for re-reversal, and is reversed. At times S710 to S712, the first document is discharged from the image reading apparatus, and the second document is also reversed and is discharged.

According to the present exemplary embodiment, in place of the image reading apparatus of the reading unit 105 in FIG. 1 according to the first exemplary embodiment, the example is given of the image reading apparatus with high efficiency in FIGS. 8 and 9.

Similarly to the first exemplary embodiment, when the document gets jammed during conveyance of the document in FIG. 7, the CPU 101 detects the jam with the sensors in FIG. 8 and also detects the jam position, and displays a jam position image prepared depending on the jam position on the operation unit 107.

According to the second exemplary embodiment, two documents simultaneously stay on the conveyance path. Therefore, if a two-sided document without page numbers, whose arrangement order of sheets is not grasped by the user, gets jammed during two-sided reading, the possibility of difficulty of correct resetting of the document is higher than that in the first exemplary embodiment.

According to the present exemplary embodiment, when the document gets jammed, the CPU 101 performs control to display information on the jam position of the document, the arrangement order thereof, and the front and back surfaces of the jammed document to the user via the operation unit 107 with the following procedure.

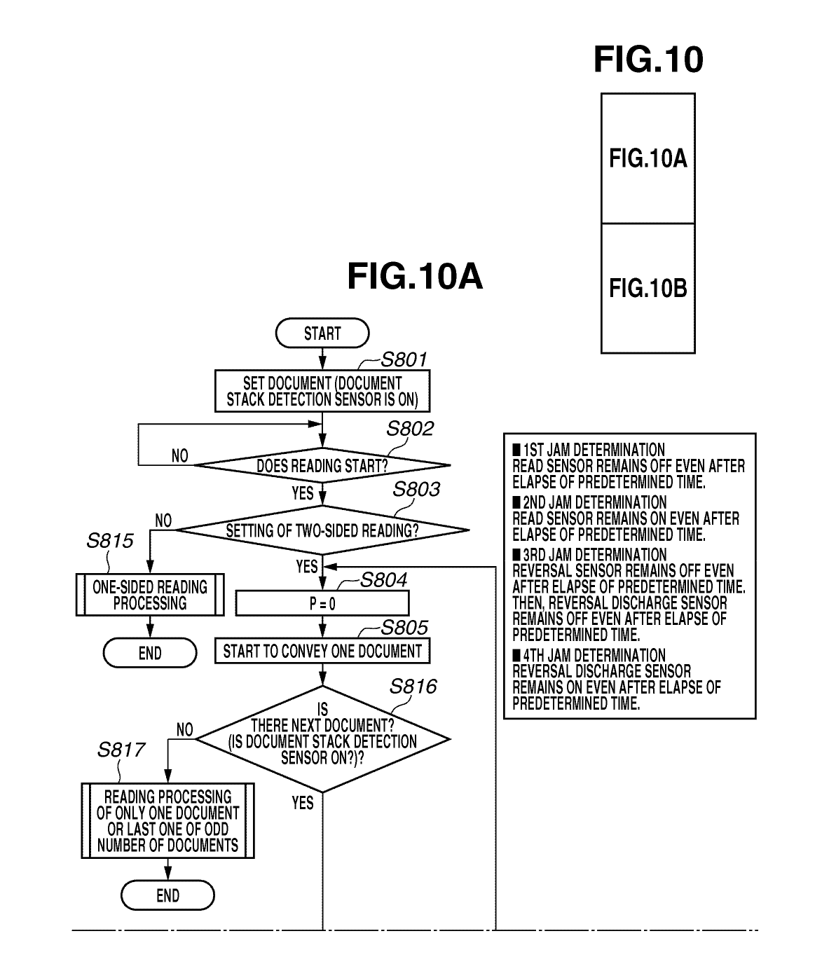

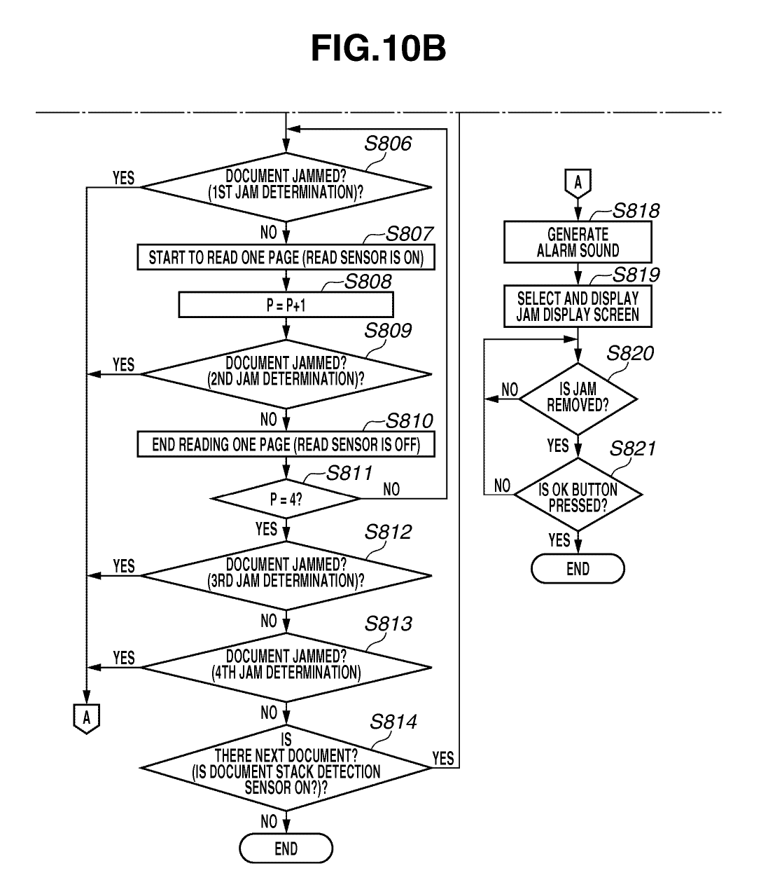

FIG. 10, which is composed of FIGS. 10A and 10B, illustrates a flowchart of a control procedure for the image reading apparatus according to the present exemplary embodiment. An example illustrates processing for displaying the jam detection executed by the CPU 101 of the image reading apparatus and the jam state corresponding to the jam position. Steps are realized by loading a control program stored in the ROM 102 to the DRAM 104 and executing the program by the CPU 101. A description is given of processing for displaying the jam information by the CPU 101 based on a change of the document conveyance state detected by the sensors 618, 619, 620, 621, and 622 and the number of passage times of the document through the read sensor 613.

The user sets a plurality of two-sided documents to the document positioning plate 600, and the sensor 618 for detecting the document stack state is turned on. In step S801, the CPU 101 detects that the document for two-sided reading is placed on the document positioning plate 600. In step S802, the user performs various reading settings for the placed document for two-sided reading with the operation unit 107, and presses a reading start button. After starting of reading, the roller 610 is driven to convey the document toward the read sensor 613 on the conveyance path. In step S803, the CPU 101 determines whether the user has set two-sided reading as a document reading condition. If the CPU 101 determines that the user has set one-sided reading (NO in step S803), then in step S815, the CPU 101 executes conventional one-sided reading processing, and the processing ends.

Similarly to the first exemplary embodiment, specific processing contents of the one-sided reading are out of the essentials, and are not described.

If the CPU 101 determines that the user has set two-sided reading (YES in step S803), then in step S804, the CPU 101 sets “0” to the parameter P. In step S805, the CPU 101 starts to drive the roller 610, pulls in one of the placed documents to the conveyance path from the document positioning plate 600, and starts to convey the document.

After pulling in one document, in step S816, the CPU 101 detects whether there is a next document on the document positioning plate 600 with the sensor 618. If the CPU 101 determines that there is not a next document (NO in step S816), then in step S817, the CPU 101 recognizes processing of only one document or the last one of an odd number of documents and performs two-sided reading processing for a single document with the read sensor 613, and the processing ends.

According to the present exemplary embodiment, a jam display when two documents stay is mainly described. Therefore, the two-sided reading processing for a single document is not described in detail.

In the two-sided reading processing for a single document with an image reading apparatus capable of allowing two documents to stay, the conveyance system is different. However, basically, a jam is detected with the sensors, the jam position is detected, and the jam is displayed similar to the foregoing.

If the CPU 101 determines that there is a next document (YES in step S816), the CPU 101 waits for reach of the conveyed document near the read sensor 613. In step S806, the CPU 101 determines whether the document gets jammed based on whether the sensor 619 is turned on within a predetermined time. If the CPU 101 determines that the sensor 619 is turned on within the predetermined time (NO in step S806), then in step S807, the CPU 101 starts to read the document with the read sensor 613. In step S808, the CPU 101 increments the parameter P each time reading of a document is performed.

The value of the parameter P indicates the number of passage times of a document through the sensor 619. The value of the parameter P ranges 0 to 4 because two documents stay in the image reading apparatus.

In step S809, the CPU 101 determines whether the sensor 619 is turned on during the passage of the document through the read sensor 613 but is turned off after the elapse of a predetermined time, thereby determining whether the document gets jammed (second jam) at the position of the read sensor 613.

If the CPU 101 determines that the sensor 619 is turned off after the elapse of the predetermined time (NO in step S809), then in step S810, the CPU 101 determines that the document normally passes through the read sensor 613, and the reading of one page ends.

At this stage, the value of the parameter P is one of 1, 2, 3, and 4. The parameter P has the values after the front edge of the document passes through the sensor 619 located just before the read sensor 613. More specifically, if P=1, the front surface of the first document is read. If P=2, the front surface of the second document is read. If P=3, the back surface of the first document is read. If P=4, the back surface of the second document is read.

In step S811, the CPU 101 determines whether the current value of the parameter P is 4. If the parameter P is 1, 2, or 3, the first or the second document needs to be conveyed again to the read sensor 613. If the CPU 101 determines that the parameter P is not 4 (NO in step S811), the processing returns to step S806, in which the CPU 101 waits for the sensor 619 to be turned on again within the predetermined time.

If the CPU 101 determines that the parameter P is 4 (YES in step S811), this state indicates a stage from the reading start of the second document to the discharge thereof.

In discharging the document, the document temporarily stays before the sensor 622, which detects the reversal, the document is externally fed from the re-reversal exit 605, the conveyance path is switched, the document passes through the front side of the sensor 622, which detects the reversal and discharge state, and the document is discharged from the lower reversal exit 604.

In step S812, the CPU 101 determines whether the sensor 622 remain off even after the elapse of a predetermined time or the sensor 622 is turned off within a predetermined time after the sensor 622 is temporarily turned on. That is, in step S812, the CPU 101 determines whether the document gets jammed at the position of the sensor 622 (whether the third document jam occurs). If the CPU 101 determines that the third document jam occurs (YES in step S812), the CPU 101 executes processing in step S818 and subsequent steps.

If the CPU 101 determines that the third document jam does not occur (NO in step S812), then in step S813, the CPU 101 determines whether the fourth document jam occurs. Specifically, if the CPU 101 determines that the sensor 621 remain on even after the elapse of a predetermined time, the CPU 101 determines that the fourth document jam occurs.

If the CPU 101 determines that the fourth document jam occurs (YES in step S813), the CPU 101 executes processing in step S818 and subsequent steps.

If the CPU 101 determines that the fourth document jam does not occur (NO in step S813), the CPU 101 determines that the two documents are normally discharged. In step S814, the CPU 101 determines with the sensor 618 whether there is a next document on the document positioning plate 600.

If the CPU 101 determines that there is a next document on the document positioning plate 600 (YES in step S814), the processing returns to step S804, in which the CPU 101 clears the parameter P to zero, and starts to convey a new document.

If the CPU 101 determines that there is not a next document on the document positioning plate 600 (NO in step S814), the processing ends.

If in steps S806, S809, S812, and S813, the CPU 101 determines that the document gets jammed, the processing proceeds to step S818.

In step S818, the CPU 101 entirely stops the conveyance system, and generates alarm sound for informing the user of the jam. In step S819, the CPU 101 selectively reads a display image for displaying the jam information on the operation unit 107 from the ROM 102, and displays the display image as a jam display screen. An example of a display screen configuration is described below with reference to FIG. 9.

In step S820, the CPU 101 determines, while monitoring the states of the sensors, whether the jammed document is removed by the user checking the screen displayed on the operation unit 107. If the image reading apparatus has a configuration in which the jammed document can be removed by opening an open/close door, the CPU 101 also monitors an ON/OFF state of a button switch for detecting the open/close state of the door.

In step S821, the CPU 101 determines whether the user presses an OK button of the operation unit 107 after the jammed document is removed on the conveyance path. If the CPU 101 determines that the user presses the OK button (YES in step S821), the CPU 101 determines that the jammed document is removed on the conveyance path and the reading processing ends. According to the present exemplary embodiment, the CPU 101 executes steps S804 to S814 to determine, based on the value of the parameter P, which one of the front and back surfaces of the document, the upper surface of the jammed document stopping at the jam position corresponds to. Then, the CPU 101 displays, on a display portion of the operation unit 107, jam information including the jam position of the jammed document, information on the front or back surface indicating which one of the front and back surfaces of the document, the upper surface of the jammed document corresponds to, and information indicating the order of documents. Thus, the user can place again the front surface of the jammed document faced up on the document positioning plate 600 and correctly restart the reading of the document.

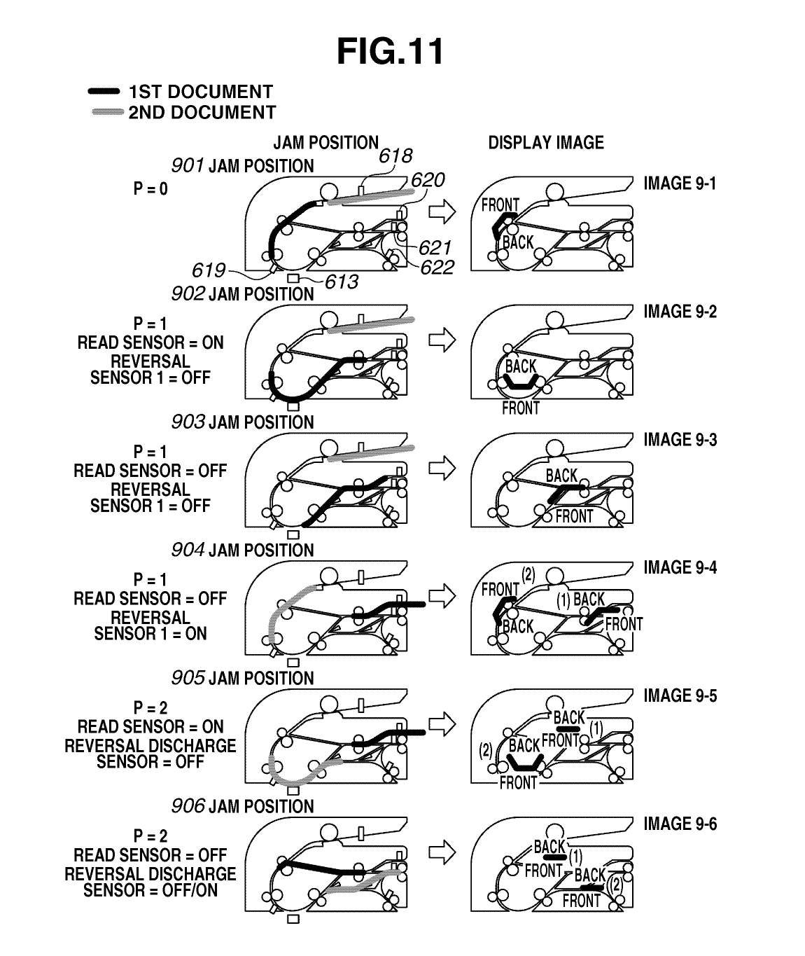

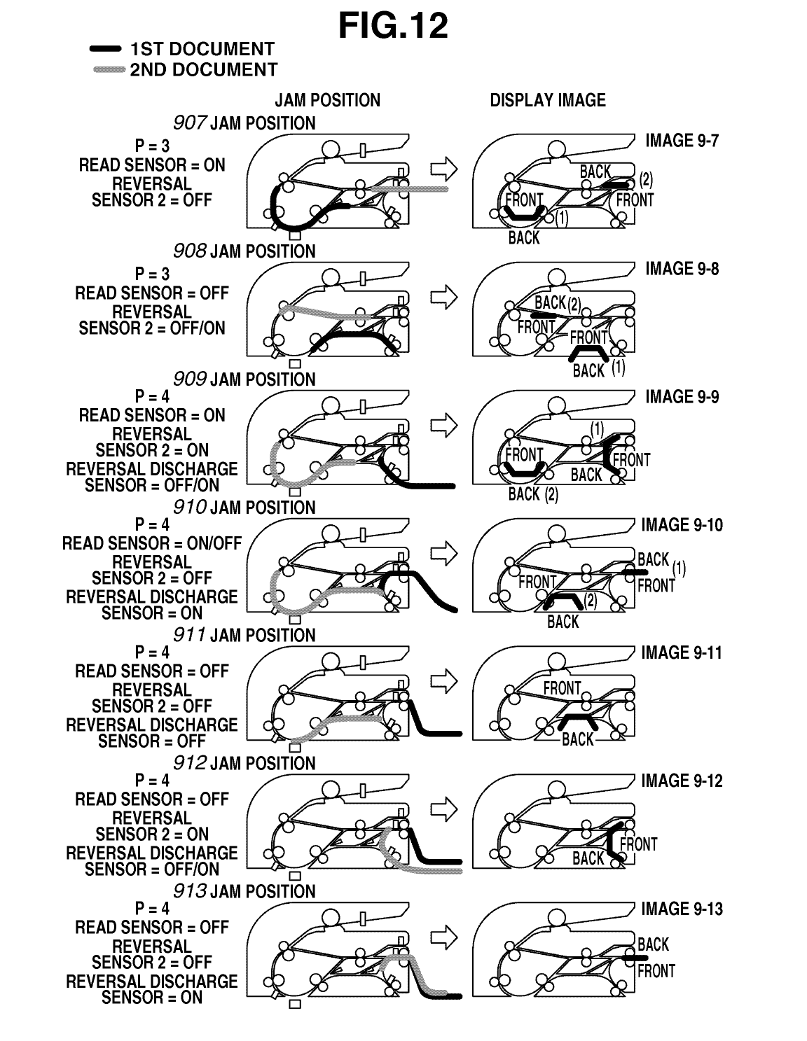

FIGS. 11 and 12 illustrate a corresponding relation between the document jam position in the image reading apparatus and the display image according to the present exemplary embodiment. Similar to the first exemplary embodiment, display images 9-1 to 9-13 are stored in advance in the ROM 102. Referring to FIGS. 11 and 12, (1) and (2) indicate the order of conveyed documents. Information indicating the order of conveyed documents is not limited to the illustrated example. If the image reading apparatus has a color display as another example, the document corresponding to the order (1) of conveyed documents may be illustrated by red and numeral, and the document corresponding to the order (2) of conveyed documents may be illustrated by green and numeral. Alternatively, a resetting state of the document may be displayed with a moving image, such as animation indication.

FIG. 11 illustrates an example of a correspondence between an approximate jam position assumed when the document gets actually jammed and a display image of the jam occurrence displayed on the operation unit 107. As described above according to the first exemplary embodiment, the display images are examples and any display image may be used to clearly inform the user of the document position and the front or back surface.

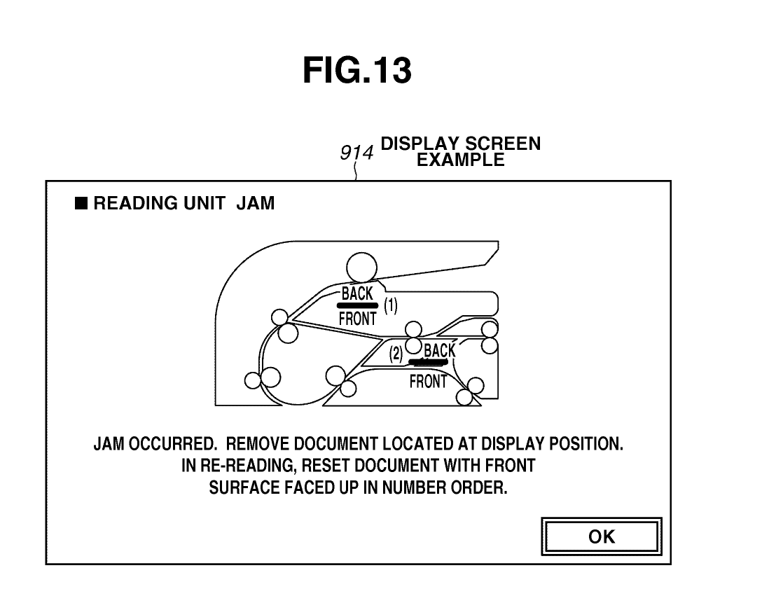

If the parameter P=0, when the CPU 101 detects that the document gets jammed by the first document jam determination in step S806, the CPU 101 determines that the document gets jammed at a jam position 901. The CPU 101 selectively reads an image 9-1 as the display image from the ROM 102, and performs control to display the image 9-1 as a user interface in FIG. 13 on the operation unit 107.

If the parameter P=1, when the CPU 101 detects that the document gets jammed by the second document jam determination in step S809 or the first document jam determination in step S806, the CPU 101 specifies the jam position as follows. Specifically, the CPU 101 determines that the document stops, getting jammed at any of jam positions 902, 903, and 904 on the conveyance path. The CPU 101 determines the approximate document position from states of the sensors 619 and 620 when the jam is detected.

If the sensor 619 is turned on in this state, the CPU 101 determines that the document gets jammed during reading of the document. Therefore, the CPU 101 selectively reads an image 9-2 as the display image from the ROM 102, and performs control to display the read image 9-2 as a user interface in FIG. 13 on the operation unit 107.

If the sensor 619 is turned off and the sensor 620 is turned off, the CPU 101 selectively reads an image 9-3 as the display image from the ROM 102, and performs control to display the read image 9-3 as a user interface in FIG. 13 on the operation unit 107.

If the sensor 619 is turned off and the sensor 620 is turned on, since the second document is conveyed inside the apparatus, the CPU 101 selectively reads an image 9-4 as the display image from the ROM 102. The CPU 101 performs control to display the read image 9-4 as a user interface in FIG. 13 on the operation unit 107.

According to the present exemplary embodiment, a display image when two documents stay in the apparatus includes numerals to discriminate between the document first conveyed to the apparatus and the document conveyed later thereto, in addition to the approximate document positions and the information on the front or back surface. Thus, when the document gets jammed, the user can also grasp the arrangement order of documents for resetting the documents.

If the parameter P=2, when the CPU 101 determines that the document gets jammed by the second document jam determination in step S809 or the first document jam determination in step S806, the CPU 101 determines that the document is at a jam position 905 or 906. The CPU 101 specifies the approximate document jam position only by the status of the sensor 619 when the document gets jammed.

When the sensor 619 is turned on, the CPU 101 determines that, while the front surface of the second document is being read, the first document gets jammed when it is discharged toward the upper reversal exit 603. Therefore, the CPU 101 selectively reads an image 9-5 as the display image from the ROM 102, and performs control to display the read image 9-5 as a user interface in FIG. 13 on the operation unit 107.

If the sensor 619 is turned off, the CPU 101 determines that, while the first document is being conveyed to the sensor 619, the second document gets jammed when it is conveyed toward the lower reverse exit 604. Therefore, the CPU 101 selectively reads an image 9-6 as the display image from the ROM 102, and performs control to display the read image 9-6 as a user interface in FIG. 13 on the operation unit 107.

If the parameter P=3, when the CPU 101 determines that the document gets jammed by the second document jam determination in step S809 or the first document jam determination in step S806, the CPU 101 determines that the document stops, getting jammed at a jam position 907 or 908. Similarly to P=2, the CPU 101 specifies the approximate document jam position only by the status of the sensor 619 when the jam is detected.

If the sensor 619 is turned on, the CPU 101 determines that, while the back surface of the first document is being read, the second document gets jammed when it is discharged toward the lower reversal exit 604. Therefore, the CPU 101 selectively reads an image 9-7 as the display image from the ROM 102, and performs control to display the read image 9-7 as a user interface in FIG. 13 on the operation unit 107.

If the sensor 619 is turned off, the CPU 101 determines that, while the first document is being conveyed toward the re-reversal exit 605, the second document gets jammed when it is conveyed to the sensor 619. Therefore, the CPU 101 selectively reads an image 9-8 as the display image from the ROM 102, and performs control to display the read image 9-8 as a user interface in FIG. 13 on the operation unit 107.

If the parameter P=4, when the CPU 101 detects the document jam by the second document jam determination in step S809, the third document jam determination in step S812, and the fourth document jam determination in step S813, the document gets jammed at any of jam positions 909 to 913. In this case, the CPU 101 specifies the approximate document position by the statuses of the sensors 619, 622, and 621.

If the sensor 619 is turned on, the CPU 101 determines that, while the back surface of the second document is being read, the first document gets jammed when it is to be discharged from the lower reversal exit 604. Therefore, the CPU 101 selectively reads an image 9-9 as the display image from the ROM 102, and performs control to display the read image 9-9 as a user interface in FIG. 13 on the operation unit 107.

If the sensor 619 is turned on or off, the sensor 622 is turned off, and the sensor 621 for reversal and discharge is turned on, the CPU 101 determines that the first document is located just before being discharged and the second document is located between the sensors 619 and 622. Therefore, the CPU 101 selectively reads an image 9-10 as the display image from the ROM 102, and performs control to display the read image 9-10 as a user interface in FIG. 13 on the operation unit 107.

If all of the sensors 619, 622, and 621 are turned off, the CPU 101 determines that the first document has been discharged and the second document is located between the sensors 619 and 622. Therefore, the CPU 101 selectively reads an image 9-11 as the display image from the ROM 102, and performs control to display the read image 9-11 as a user interface in FIG. 13 on the operation unit 107.

If the sensor 619 is turned off and the sensor 622 is turned on, the CPU 101 determines that the second document is located at the position for reversal to discharge, irrespective of the sensor 621. Therefore, the CPU 101 selectively reads an image 9-12 as the display image from the ROM 102, and performs control to display the read image 9-11 as a user interface in FIG. 13 on the operation unit 107.

If the sensors 619 and 622 are turned off and the sensor 621 is turned on, the CPU 101 determines that the second document is located just before being discharged. Therefore, the CPU 101 selectively reads an image 9-13 as the display image from the ROM 102, and performs control to display the read image 9-13 as a user interface in FIG. 13 on the operation unit 107.

According to the present exemplary embodiment, the CPU 101 selectively reads the value of the parameter P and the display image corresponding to the statuses of the sensors, and performs control to display the jam information by using the user interface in FIG. 13 on the operation unit 107.

When the document gets jammed if the parameter P=2, a display screen example 914 in FIG. 13 is obtained by selectively reading the corresponding image 9-6 from the ROM 102 and is displayed on the operation unit 107. The screen is displayed on the operation unit 107. Thus, the user can checks that the document gets jammed in the reading unit 105, and can intuitively understand the approximate document jam position, the arrangement of documents, and which one of the front and back surfaces of the document the reading surface is.

Thus, if any document stops on the conveyance path in the jam state, the user can check a screen display in FIG. 13 on the operation unit 107 to remove the document. Further, the user can correctly reset any removed document to the document positioning plate 600 so that the front surface is faced down.

According to the present exemplary embodiment, when the document is two-sided read in the apparatus and the document gets jammed, it is possible to display the document jam position in the image reading apparatus and the direction of the front or back surface, and the reading order of documents when there is a plurality of documents in the apparatus. Thus, even in the case of two-sided documents to which page numbers are not assigned and of which the user does not grasp the arrangement order, the user can intuitively understand the arrangement of documents. Therefore, the user can easily reset the documents.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium). In an example, a computer-readable storage medium may store a program that causes an image reading apparatus to perform a method described herein. In another example, a central processing unit (CPU) may be configured to control at least one unit utilized in a method or apparatus described herein.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-083688 filed Apr. 5, 2011, which is hereby incorporated by reference herein in its entirety.

What is claimed is:

1. An image reading apparatus comprising:
a conveyance unit configured to convey a document via a conveyance path;
a reading unit configured to read an image of a first surface or a second surface of the document conveyed by the conveyance unit;
a detection unit configured to detect a conveyance state of the document on the conveyance path; and
a control unit configured to perform control to display, on a display unit, a position of the document, and front information or back information indicating, respectively, the first surface and the second surface of the document according to the conveyance state of the document detected by the detection unit.

2. The image reading apparatus according to claim 1, further comprising:
a determination unit configured to determine whether a jam of the document occurs,
wherein, in a case where the determination unit determines that a jam of the document occurs, the control unit is configured to perform control to display, on the display unit, the position of the document, and the front information or back information indicating, respectively, the first surface and the second surface of the document according to the conveyance state of the document detected by the detection unit.

3. The image reading apparatus according to claim 1, wherein the reading unit is configured to read a first surface of a first document conveyed by the conveyance unit, a first surface of a second document subsequent to the first document, and a second surface of the first document in this order,
wherein the control unit is configured to perform control to display, on the display unit, a position of the first document and a position of the second document, and, according to the conveyance state of the document detected by the detection unit, the front information or back information indicating, respectively, the first surface and the second surface of the first document, and the first surface or the second surface of the second document.

4. The image reading apparatus according to claim 1, wherein the reading unit is configured to read a first surface of a first document conveyed by the conveyance unit, a first surface of a second document subsequent to the first document, and a second surface of the first document in this order,
wherein the control unit is configured to perform control to display, on the display unit, a position of the first document and a position of the second document according to the conveyance state of the document detected by the detection unit, and
wherein the control unit is configured to discriminably display which of the displayed position of the first document and the displayed position of the second document indicates the position of the first document.

5. An image reading apparatus comprising:
a conveyance unit configured to convey a document via a conveyance path;
a reading unit configured to read a first surface of a first document conveyed by the conveyance unit, a first surface of a second document subsequent to the first document, and a second surface of the first document in this order;
a detection unit configured to detect a conveyance state of the document on the conveyance path; and
a control unit configured to perform control to display, on a display unit, a position of the document according to the conveyance state of the document detected by the detection unit, wherein the control unit is configured to perform control to discriminably display which of the displayed position of the first document and the displayed position of the second document indicates the position of the first document.

6. A method for controlling an image reading apparatus, the method comprising:
conveying a document via a conveyance path;
reading an image of a first surface or a second surface of the conveyed document;
detecting a conveyance state of the document on the conveyance path; and
performing control to display, on a display unit, a position of the document and front information or back information indicating, respectively, the first surface and the second surface of the document according to the detected conveyance state of the document.

7. A non-transitory computer-readable storage medium storing a program that causes an image reading apparatus to perform the method according to claim 6.
